(19) United States
(12) Patent Application Publication
(10) Pub. No.: US 2013/0073303 A1
(43) Pub. Date: Mar. 21, 2013

(54) CARE SYSTEM

(71) Applicant: Tseng Jan Hsu, Plesanton, CA (US)

(72) Inventor: Tseng Jan Hsu, Plesanton, CA (US)

(21) Appl. No.: 13/610,553

(22) Filed: Sep. 11, 2012

Related U.S. Application Data
(60) Provisional application No. 61/536,956, filed on Sep. 20, 2011.
(60) Provisional application No. 61/606,867, filed on Mar. 5, 2012.

(51) Int. Cl. G06Q 50/22; G06F 17/00; H04L 12/28

(52) U.S. Cl. 705/2; 370/401; 700/236

(57) ABSTRACT

A care system uses sensors and a gateway to collect activity or health information of a home user and reports the information to a service that provides the information to the home user and authorized remote users. A motion sensor can sense an activity level of the home user, e.g., indicating the amount of motion per minute, and reports the motion data periodically at a reporting period selected to provide manageable data rates. A pillbox sensor can sense and report use of medication by the home user. The service that provides data can employ a business method that sells care systems and separate sensors, licenses interfaces that enable use of sensors in a care system, sells Internet advertisements on web pages that contain the health data, and sells enhanced service, e.g., higher data collection frequencies, to remote users.

### CROSS-REFERENCE TO RELATED APPLICATIONS

This patent document claims benefit of the earlier filing date of U.S. provisional pat. App. No. 61/536,956, filed Sep. 20, 2011, and U.S. provisional pat. App. No. 61/606,867, filed Mar. 5, 2012, both of which are hereby incorporated by reference in their entirety.

### BACKGROUND

Many countries are experiencing a general aging of their populations. For example, the United States currently has about 40 million people over the age of 65 and is expected to have more than 55 million people over age 65 by 2020. The 65-and-over age group is accordingly one of the fastest growing population segments in the United States. Today about 80% of people over age 65 in the U.S. live in their own homes, and surveys indicate that 90% of those would like to stay in their homes as long as health permits it. With life expectancy expected to reach 90 years of age, many people will be living independently to advanced ages. However, health issues become more common with advancing age making independent living more difficult. Often the family or friends of people with health conditions worry about people living alone and would like to know that their loved ones are well. Distance and other factors may not permit visits with sufficient frequency to allay concerns, and available communication methods such as telephone calls may not be effective, particularly when such communications do not result in an immediate connection with or response from the person being contacted. Electronic monitoring can provide current information about a person's activity, health, or well being that would help ease concerns, but monitoring can intrude on privacy in a manner that many may find objectionable. Even when a person desires a monitoring system, a barrier to use of a monitoring system is that setting up a monitoring system may be so complex that professional installation is required, and after installation, the system may be difficult for the average user to control or use. Also, the initial and ongoing expense of electronic monitoring can be a problem particularly for people on a fixed income. An activity monitoring solution is desired that would be easy to install, have a low start up cost, have no or minimal ongoing cost, cause only acceptable intrusions to privacy, provide authorized parties such as family members or doctors with easy access to information, and keep information confidential to the authorized parties.

### SUMMARY

A care system can collect health information of a home user and provide the health information to authorized remote users, e.g., through Internet website. Accordingly, authorized family members, friends, or medical professionals as remote users can check on the health of the home user, even when the home user lives halfway around the world. Collected health information can include activity of a home user, and in accordance with one aspect of the invention, a level of activity can be indicated through a level of movement of the home user during specified reporting periods. The level of movement can be, for example, a count of the number of times one or more motion sensors detect movement of the home user during a minute or other time interval. Such counts can be collected at sensors and reported periodically, e.g., about every ten minutes, to reduce radio traffic in the home environment and reduce internet traffic to a service provider.

In one configuration of a care system, sensors that detect indications of activity or health of a user communicate with a local gateway using low-power wireless communication links, so that the sensors can operate for an extended time using household batteries or outlets. A “portable” motion detector using a battery may be particularly easy to set up, configure, and use in a home environment. However, some sensors may use a household power supply such as a standard electrical outlet. For example, a power monitor or a motion sensor that does require portability may directly plug into a household power plug. The local gateway can communicate with local sensors and with an Internet server that provides information to authorized users.

In accordance with another aspect of the invention, a pillbox or medication dispenser having multiple compartments with each compartment corresponding to a day of the week or another time interval can sense or infer when medication is removed and report medication activity to the local gateway of a care system. The care system can process the information from the pillbox and determine or infer whether the home user is taking medication according to an established schedule.

Cumulative historical data collected by a care system can be used to assist a senior's doctor by providing accurate health condition information (e.g., blood pressure data or living behavior changes) over an extended period of time (e.g., analyzed daily, weekly, or monthly). For example, motion monitoring data may indicate a variety of very specific events such a decrease in daily activity or an increase in sleepless nights. Accurate measurements or determinations of such trends over extended periods of time might otherwise be difficult to detect. A doctor may have difficulty in identifying behavior changes during a single examination of a patient.

One specific embodiment of the invention is a care system that includes a gateway and one or more sensor. a sensor configured to detect activity in a home environment within a plurality of detection periods, count the detection periods during which activity was sensed, and report one or more counts of activity; and

One specific embodiment of the invention is a care system that includes a gateway and one or more sensor. An activity or motion sensor can be configured to detect activity in a home environment within a series of detection periods, count the detection periods during which activity was sensed, and report to the gateway one or more counts of activity. The gateway can be configured to receive reports from the sensor and to send to a service provider information based on the counts and indicating the activity sensed in the home environment.

Another specific embodiment of the invention is s monitoring process. The process includes: operating a sensor during a series of count intervals, wherein each count interval includes a plurality of detection intervals; for each of the count intervals, determining a count of the detection intervals that are in the count interval and during which the sensor detected activity in a home environment of a first user; reporting the counts to a local gateway; and sending from the local gateway to a remote service provider information based on the counts and indicating the activity sensed in the home environment.

Still another embodiment of the invention is a dispenser that includes: medication compartments; sensors arranged to detect accesses to respective medication compartments; and an interface coupled to the sensors and configured to report the accesses.

Yet another embodiment of the invention is a process that includes establishing a care system in a home environment of a home user. With the established care system the process can further report health information from the care system to a service that is accessible by a remote user. The care system may normally report the health information with one frequency, but in response to a purchase, the care can operate to report the health information to the service at a higher frequency.

### BRIEF DESCRIPTION OF THE DRAWINGS

FIG. 1 is a block diagram of a care system in accordance with an embodiment of the invention.

FIG. 2 is a block diagram illustrating a low power wireless connection of a sensor to a gateway in a care system in accordance with an embodiment of the invention.

FIGS. 3A, 3B, 3C, 3D, and 3E show sensors that can communicate with a gateway in a care system in accordance with an embodiment of the invention.

FIG. 4 illustrates two alternative data transmissions resulting from movement monitored in a care system in accordance with an embodiment of the invention.

FIG. 5 is a flow diagram of a process for collecting and communicating motion information from a sensor in a care system in accordance with an embodiment of the invention.

FIG. 6 is a flow diagram of a process for collecting and communicating activity information at a smart gateway in a care system in accordance with an embodiment of the invention.

FIG. 7 illustrates a graphical representation of information collected and processed in a care system in accordance with an embodiment of the invention.

FIGS. 8A and 8B illustrate graphs that a care system in accordance with an aspect of the current invention can provide to represent the activity levels of a home user as a function of time.

Use of the same reference symbols in different figures indicates similar or identical items.

### DETAILED DESCRIPTION

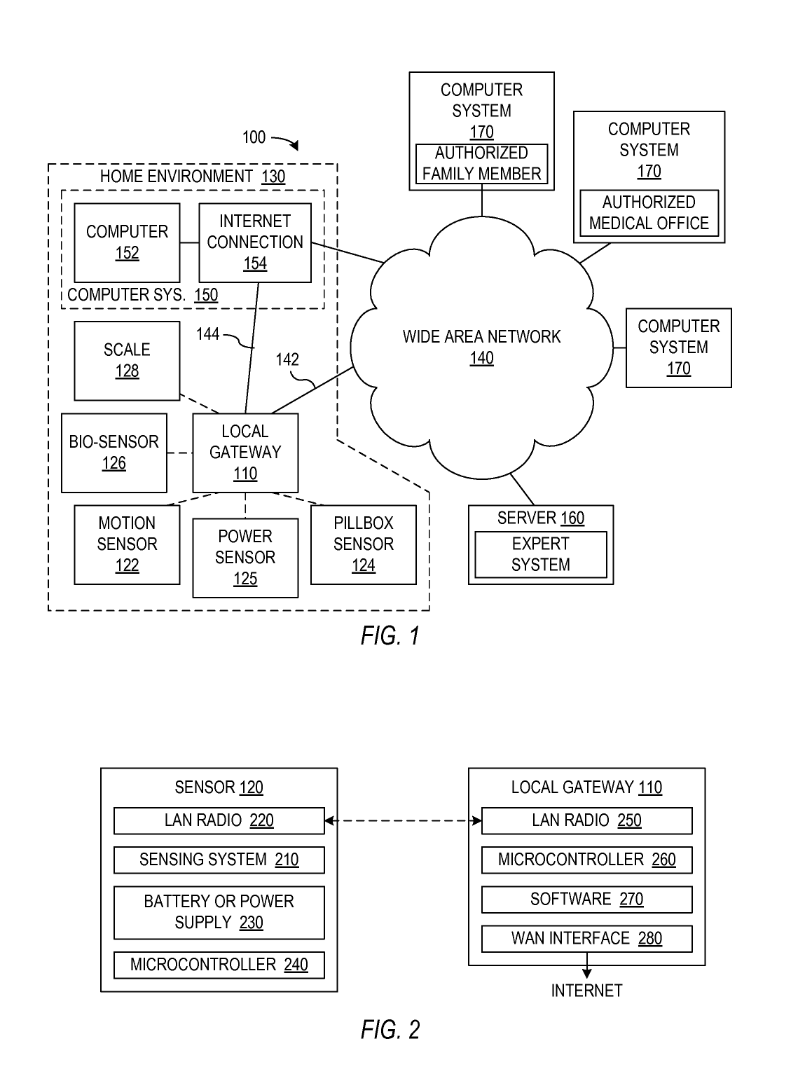

FIG. 1 is a block diagram of a care system 100 in accordance with an embodiment of the invention. Care system 100 includes a gateway 110 and multiple sensors 122, 124, 125, 126, and 128 that can be set up in a home environment 130. Home environment 130 in the exemplary embodiment described further below may be a user's abode such as an apartment, a condominium, or a house and may further include surroundings or outdoor areas such as balconies, front yards, backyards, or outbuildings associated with a home user's abode. In yet other embodiments of system 100, home environment 130 could alternatively be a facility such as a long-term care facility.

Gateway 110 is generally capable of communicating with sensors 122, 124, 125, 126, and 128 and a wide area network (WAN) 140 such as the Internet. FIG. 1 illustrates two alternative connections 142 and 144 that gateway 110 could use for connecting to WAN 140. Remote connection 142 is a direct connection to resources outside home environment 130 and may be, for example, a wired connection such as telephone lines or a wireless data connection. In one embodiment, connection 142 implements a wireless telephone standard such as the 3G or 4G telecommunication standard, which enables gateway 110 to connect to external infrastructure in WAN 140 via a 4G modem router, a cell phone, or smart phone. Alternatively, local connection 144 allows gateway 110 to connect to WAN 140 through the available resources in home environment 130. For example, many home environments include a computer system 150 that includes one or more computer 152 and some type of Internet connection 154. For example, Internet connection 154 may include a modem and a wireless router such as a Wi-Fi access point router. If no home network is available, local connection 144 can connect gateway 110 directly to a computer 152 or modem through a wired connection or through a wireless connection such as a Bluetooth connection. Local connection 144 could be made using many known interfaces including but not limited to Wi-Fi, Bluetooth, or other wireless communication or wired connections such as USB or Ethernet connections. If no computer system 150 or Internet connection 154 is available in home environment 150, local gateway 110 may need to connect to external network 140 through a direct connection such as connection 142. Many other communication configurations and systems could be used in still other embodiments.

The sensor side of gateway 110 in the illustrated embodiment includes a motion sensor 122, a pillbox sensor 124, a power sensor 125, a bio-sensor 126, and a scale 128, which are described further below. More generally, a user would select the particular number and types of sensors to be included in home environment 130. Care system 100 may include zero, one, or more than one of each type of sensor 122, 124, 125, 126, or 128 and include sensors of other types (not shown). A system may, for example, include a FSK-Wi-Fi host gateway 110, two motion sensors 122, and one or more customer selected optional sensors.

Each sensor 122, 124, 125, 126, or 128 may have a basic structure illustrated by the generic sensor 120 shown in FIG. 2. In particular, each sensor 120 includes a sensing system 210 of some type to measure or detect some type of indicator of the activity or health of the home user and a radio 220 for communication with local gateway 110. Radio 220 can be powered by a battery or a household electricity and preferably has a low-power operating mode to permit portable operation of sensor 120 or operation of sensor 120 for extended periods of time, e.g., on the order of a year, using a conventional battery system without need for recharging. For example, radio 220 may use an ISM sub-GHZ radio bands such as employed in some remote control systems and can transmit data using a standard or proprietary data protocol. Radio 220 could alternatively implement a standard wireless protocol such as ZigBee, Bluetooth, or Wi-Fi. However, many standard protocols, particularly Wi-Fi protocols, can be difficult to implement in a manner that can operate for extended periods of time using battery power. In the illustrated embodiment, sensor 120 also includes a microcontroller that executes suitable software to process data from sensing system 210 and to control communication of radio 220 with gateway 110.

Gateway 110 includes a radio 250, microcontroller 260 with software 270 and a wide area network (WAN) interface 280 for performing processes such as those described further herein. Radio 250 can communicate with sensors 120, and microcontroller 260 may process data received from all of sensors 120. In one embodiment, gateway 110 simply relays the communications from sensors 120 to a remote service provider, e.g., server 160, with little or no change. Accordingly, sensors 120 may be configured to minimize the number of transmissions to reduce network traffic. WAN interface 280 communicates through WAN 140 as shown in FIG. 1 with remote server 160, e.g., an Internet server system that may be operated by a health monitoring service provider. Gateway 110 can generally act as the host of the local health sensors or network, collect and process data from the sensors or health measuring devices 120, and route the data to WAN 140 and server 160. Gateway 110 may also receive communications from server 160, execute instructions from server 160, and/or communicate instructions to sensors 120 from server 160 or otherwise. In yet another option, gateway 110 may itself include a sensor or a user interface through which a home user can check in or check out to indicate to authorized users when the home user is at home. However, for system simplicity, which may be desired by many home users, gateway 110 may avoid use of a user interface. Further, home users with a computer system 150 may be able to access a web site that server 160 provides to permit users to set user options and to take actions such as checking out or in when leaving and returning to home environment 130.

Installation of the local portion of care system 100 through connection 144, which uses preexisting computing or communication resources such as a home network, may require some knowledge of the available resources in home environment 130. However, installation of care system 100 may be simpler when local gateway 110 is able to directly connect to WAN 140 through connection 142. For example, in an embodiment using direct internet connection 142, e.g., a 3G or 4G connection, gateway 110 and sensors 122, 124, 125, 126, and 128 could be simply placed in home environment 130 and powered to create the local portion of care system 100. The home user could select remote authorized users of care system 100 during purchase of gateway 110, using phone-in customer service, or using a website. In a similar manner, the home user may further be able to alter the list of authorized users and control what information each authorized user is able to access from server 160.

When system 100 of FIG. 1 is in operation, sensors 122, 124, 125, 126, and 128 may measure activity or respective indicators of the health of a home user. Gateway 110 may process or collect the information from the local sensors and communicate the same or processed information through WAN 140, e.g., the Internet or other communication system, to a server 160 that is run by a service provider. Server 160 can then make the information available to the home user and other authorized users, sometimes referred to herein as remote users. Server 160 can operate, for example, by hosting a secure web site that the home user and other authorized users can access using suitable computing systems, e.g., personal computers, laptop computers, notepad computers, or smart phones. In a typical configuration, a home user living in home environment 130 might authorize one or more remote users, for example, family members such as one or more of their children, grandchildren, or siblings or professional health care providers such as doctors or nurses to use remote computing systems 170 to access some or all of the health information available in server 160. The health information would generally be updated in real time or frequently, e.g., several times a day, hour, or minute, so that authorized users could check the current health information for the home user.

Server 160 could provide the health information either in raw form or in a processed form as described further below and may be configured to generate automated warnings under predefined or user selected circumstances. The home user might use the information available from server 160 as reminders of health activities that may be needed or as a record of their activity. Family members might use the health information to assure themselves that the monitored person is well or to detect when some action might be needed to help the monitored person. For example, a remote user that first attempts to reach the home user by telephone could check server 160 for current health or activity information if the home user doesn't answer the call. Similarly, server 160 may alter an authorized user to telephone or otherwise check on the home user. Professional health care providers might further use the health information for diagnostic purposes. In particular, historical data collected and processed by local gateway 110 or server 160 may also be good support or reference information to assist a medical professional when examining the home user, e.g., during a doctor visit.

Server system 160 of the monitoring service provider or a suitable computer system 170 of an authorized service provider could implement real time automated actions in response to health information that server 160 accumulates. For example, an expert system, knowledgebase, or similar software can evaluate health information and generate automated responses such as sending messages to the home user, an authorized family member, or a medical office. A preventive care knowledgebase application, in particular, can analyze the health information collected in real time and give the home user or an authorized care giver timely or advance preventive/health care-related information or notices. For the home user, the knowledgebase can automatically send reminders or articles that are selected based on analysis of the accumulated health information, may be useful to the home user. For the care giver, the accumulated health care information and the knowledgebase can provide powerful tools for detection of conditions that are difficult to otherwise track. For example, night time motion data may provide real time or early detection of certain conditions such as a sleep disorder that may otherwise be difficult to diagnose.

The knowledgebase or expert system can also facilitate targeted advertizing. In particular, a monitoring service providing ongoing health monitoring to home users may be able to reduce or eliminate charges to the home users by charging business clients for targeted advertising. For example, once an expert system or knowledgebase recognizes certain symptoms, the expert system or knowledgebase can select business clients' related medical articles, papers, advertising, or other information and present that information to the home user or other authorized party, e.g., through a login page or a web-based interface of system 100. The home user or authorized party may benefit from contact information for doctors or specialists or from information about available treatments, medicines, and medical solutions that are directly related to the identified symptoms. Such advertising can also provide high value to the business clients in that the advertisement is targeted directly to the right group of people.

One business method that a service provider could employ would sell care system hardware such as gateway 110 and sensors 120, and provide 24/7 data access to a specific amount of information (e.g., up to 2 weeks of historical data) at no monthly fee. Service without monthly fees may be sponsored or funded through web advertisements. Such advertising may particularly be of interest to the senior care industry, insurance, pharmacy, hospital and geriatric sites. Customers, i.e., home users or remote users, could also purchase upgrades to data provided through server 160. For example, a remote user might want to increase the frequency of motion data collection to get a better resolution of the level of activity of the home user. Such purchases can be made at any time through an on-line order, for example, using the website that provides the collected health information. The service provider could also provide or sell statistical information to research institutes and the senior care industry.

Customers may be able to purchase kits for a basic configuration of the local portion of a care system 100 and at any time purchase additional optional sensors 120 to extend the capabilities of their care system 100. Such additional sensors do not need to be manufactured solely by the manufacturer of gateway 110. Radio module and device registration tags can be licensed to current manufacturers of biosensors for addition to their biosensor products. Revenue can also be generated from care systems by allowing authorized remote users to buy as needed sessions (e.g., periods of hours or days) of real time updates at a faster refresh rate, so that more information may be available during a critical time.

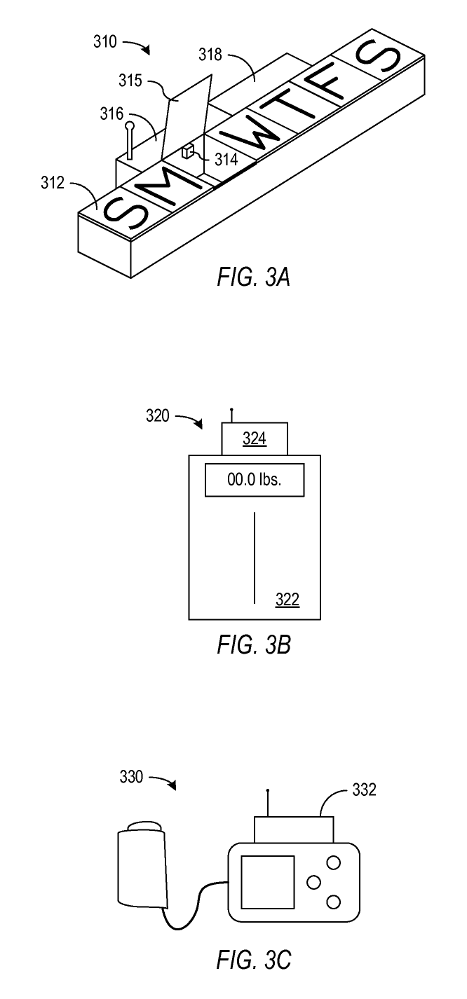

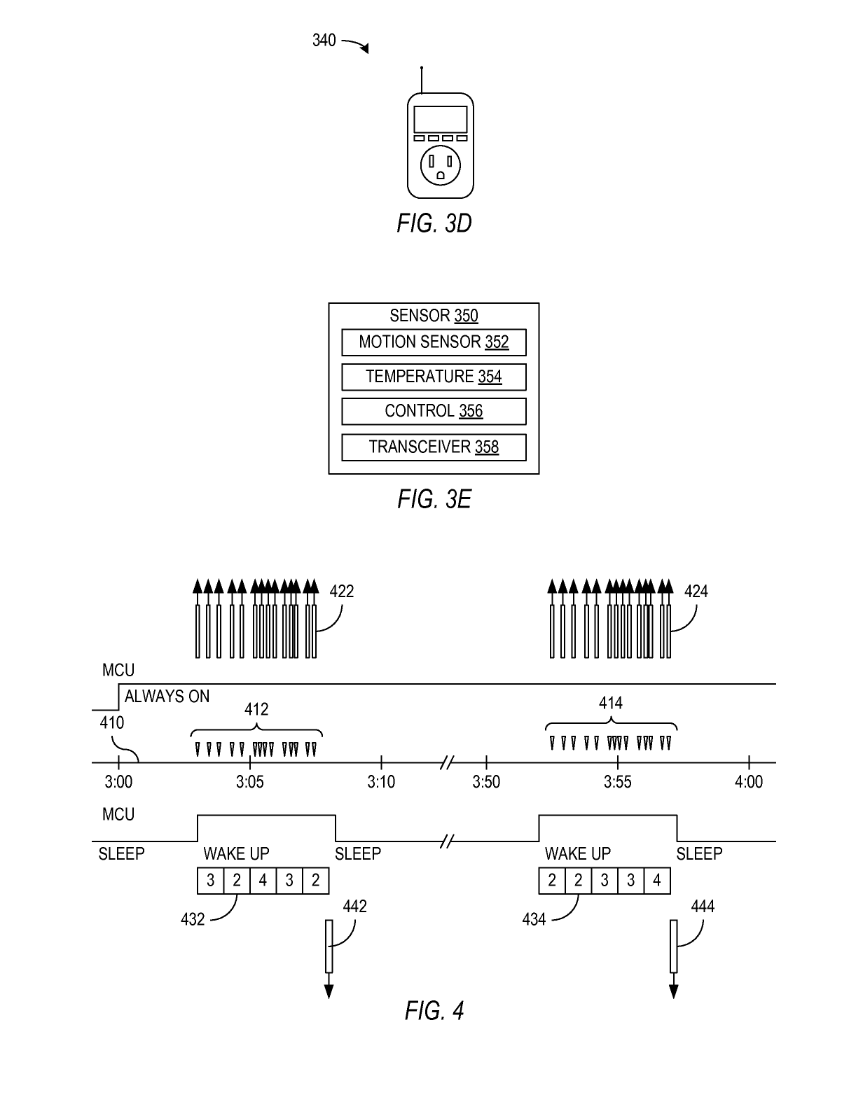

FIGS. 3A, 3B, 3C, 3D, and 3E illustrate a few specific embodiments of sensors suited for use in care system 100 of FIG. 1.

FIG. 3A particularly illustrates a pillbox sensor 310 in accordance with an embodiment of the invention. Pillbox sensor 310 includes multiple compartments 312, e.g., seven medication compartments intended to be stocked weekly with pills, medications, or devices to be taken or used on the different days of the week. Each compartment 312 has a separate sensor system 314 to sense or infer use of the contents of that compartment 312. For example, sensor systems 314 may be switches, and each compartment 312 may have a hinged lid or door 315 that operates a corresponding switch 314 when opened or closed. Although FIG. 3A illustrates a configuration in which doors 315 form the tops of compartments 312, other configurations of doors 315 may be possible. An alternative sensing system 314 for a compartment 312 can sense the presence of medication (e.g., using an optical or pressure sensor) in the compartment 312 so that the addition or removal of medication can be sensed. With compartments 312 and sensors 314 assigned to days of the week, activation of a sensor 314 on a day associated with the compartment 312 may imply that a home user took medication on the appropriate day. Similarly, if compartments 312 and sensors 314 correspond to specific times or to time periods other than a day, activation of a sensor 314 at the time or during the time period associated with the compartment 312 may imply that that home user took medication at the appropriate time.

Pillbox sensor 310 has electronics 316, e.g., a microcontroller, a clock circuit, and a LAN radio, and a battery 318, which may be used as described above with regard to FIG. 2 for communication with a local gateway of the care system. A radio system in pillbox sensor 310 may only transmit to the local gateway once or a few times a day, which may permit pillbox sensor 310 to operate for periods on the order of a year or more on conventional AA or AAA batteries. In one embodiment, pillbox 310 includes a clock or time that can be used to provide a time stamp with reports that one or more of compartments 312 have been accessed. Based on such reports, the home user or a remote user may obtain a report or record including the times when pills were taken, which is generally not possible using traditional reminder pillboxs. Battery operation may be preferred for pillbox sensor 310 because normal use of a pillbox generally includes lifting or moving pillbox 310. Further, pillbox 310 may be used in a bathroom or other environment with heightened risks of electrical shock, so that a wired connection to household power may be inconvenient and present a danger.

FIG. 3B shows a scale or body weight sensor 320 in accordance with an embodiment of the invention. Scale 320 can measure a home user's weight in a conventional manner, e.g., the home user stands on a platform 322 containing a weight or force sensing system. However, scale 320 further employs electronics 324 including a radio interface that can communicate either the use of scale 320 or the specific weight measurement to a local gateway of a care system. More specifically, use of scale 320 not only measures weight but also indicates activity of a home user. A home user may, for example, be able to configure scale 320 or the local portion of the care system to keep a weight measurement confidential, while permitting disclosure of the activity involved in using scale 320.

FIG. 3C illustrates how a radio interface 332 to a care system can be added to a biosensor or medical test system such as a blood pressure monitor 330, so that use or measurements of any biosensor can be incorporated into data collected by a care system. The biosensor portion can be a blood pressure monitor as shown in FIG. 3C, or more generally other types of biosensors such as a blood sugar monitor, a thermometer, heart rate monitor watch, or pedometer to name a few. As with a scale, a biosensor 330 can provide a specific measurement that a home user may share with authorized remote users or sharing of information can be limited to indications of activity of the home user.

FIG. 3D illustrates an electrical power monitor 340 that can also be used to detect a user's activity. For use, power monitor 340 can be plugged into a standard electrical outlet and provide an electrical outlet into which another device (not shown) can be plugged. For example, a household device such as a kitchen appliance or an entertainment device such as a television may be plugged into the outlet that power monitor 340 provides. Power monitor 340 can thus sense user activity by sensing changes in the electrical power or current drawn through monitor 340. For example, when a user turns on an electrical device such as a coffee maker or television that is plugged into power monitor 340, power monitor 340 may send a user activity signal to the local gateway of the care system.

FIG. 3E shows a room or area sensor 350 in accordance with an embodiment of the invention. Sensor 350 includes a motion sensor 352, a control module 356, and a radio transceiver 358. Motion sensing can be used to provide real-time or near real-time motion data indicative of a user's activity. Motion sensor 352 can use any available technology to detect movement. For example, motion can be electronically identified through optical or acoustical detection, and optical detection, in particular, can be active and employ a transmitted beam or be passive such as passive infrared motion detectors that detect changes in an infrared spectrum in the monitored area. Control module 356 may include a microcontroller executing a process that transmits to the local gateway indications of whether or not sensor 350 detected motion during a prior time interval. For example, control module 356 can use transceiver 358 to make one transmission per a minute or other reporting period indicating an activity level that motion sensor 352 detected during the preceding reporting period. Alternatively, sensor 350 may send transmissions to the local gateway if motion was detected during the last reporting period. However, since motion sensor 350 may remain in a fixed location and may not need to be frequently manipulated by a home user, sensor 350 may be able to employ household electrical power, instead of being limited to battery power.

Area sensor 350 in the illustrated in FIG. 3E also includes a temperature sensor 358 for sensing the temperature of a room or environment containing sensor 350. Temperature sensing may be used to check if the temperature in the home environment is being properly maintained or, for example, to indicate if a door or window was normally open or closed. Temperature sensing, like motion sensing, can be done from a fixed location, so that both a motion sensor 352 and a temperature sensor 354 may be easily incorporated in the same sensor 350. Alternatively, a temperature sensor may be omitted or provided in a separate sensor, so that sensor 340 is exclusively a motion sensor.

The sensors of FIGS. 3A to 3E are intended to illustrate a few types of sensors that may be particularly useful in a care system, but many other types of sensors could be included. For example, sensors that are conventional for security systems could also be integrated to a care system and used for care or security purposes. For example, a door sensor or similar system may be added to detect when a home user leaves or returns to their home, whether or not the door sensor is used to detect intruders. Safety systems such smoke detectors or carbon monoxide detectors could similarly be used in a care system or integrated in sensors of the types illustrated in FIGS. 3A to 3E.

Real-time monitoring of motion can produce a large amount of data and correspondingly large data flows in a local care system and from a large number of care systems to a server system of a service provider. In accordance with an aspect of the invention, processes can be employed to reduce the data flow for motion monitoring without losing the basic function of detecting healthy activity of home users. For example, when a home user is moving through a room or area that a motion sensor monitors, the motion sensor should constantly detect motion and may create a constant stream of data flowing to the local gateway. The data flow to a service provider will also be large if the local gateways of a large number of similar care systems simultaneously transmit all of the detected motion data to the service provider. In an exemplary embodiment, a motion sensor such as illustrated in FIG. 3E updates and transmits motion data periodically with a reporting period of about 1 minute, 10 minutes, or more. The data flow requirements of individual local gateways can thus be reduced, and the total data flow to a service provider can be reduced. The service provider may thus be able to employ fewer or lower capacity server systems, e.g., server 160 may have less processing power and may be less expensive that would otherwise be necessary to receive and process a larger number of data transmissions.

FIG. 4 illustrates two alternative processes for monitoring a typical movement scenario. In FIG. 4, a time line 410 has detected motion 412 of a home user at a first time and detected motion 414 of the home user at a later time. No detected movement occurs between detected motions 412 and 414, for example, because the home user is resting, asleep, or out of the home. Each detected motion 412 and 414 includes a series of movements detected by a motion detector in a sensor such as sensor 350 described above. One method reports each detected movement using two series 422 and 424 of transmissions, e.g., radio transmission to a local gateway. Each transmission in series 422 or 424 may include header information identifying the sensor, a time stamp, and an indication that a movement was sensed. For this method, a micro-controller unit of the motion sensor, e.g., control module 356 of motion sensor 350, must be available to send a signal whenever movement occurs and thus may always be powered.

A method illustrated below time line 410 shows that the MCU of the sensor may be in a sleep mode when no activity is detected and may wake up when the first movement of a series of movements is detected. For example, at the beginning of detected motion 412, the MCU wakes, counts the number of movements detected per minute or other period of time, and collects a time-ordered array 432 of such movement counts. At the end of a reporting period or when movement stops for some time, the MCU sends a transmission 442 representing motion array 432 to the local gateway. After a period of time in which no motion is detected, the MCU can then go back into a sleep mode until motion is first detected in the series 414 of detected movements. At which point, the MCU again wakes, counts detected movements, collects an array 434 of movement counts, and sends a transmission 444 representing array 434 to the local gateway of the care system. The method using transmissions 442 and 444 has advantages over the method sending transmissions 422 and 424. In particular, the MCU can use a sleep mode to reduce the power consumption of a motion sensor. Also, a sensor sending transmissions 442 and 444 may create less local radio traffic and interference than would be caused by transmissions 422 and 424. Similarly, the local gateway may simply forward count arrays 432 and 434 to the remote service provider, which allows the local gateway to be relatively simple while creating less traffic to an Internet server (e.g., server 160). Reducing traffic to server 160 is particularly important when server 160 handles data from a large number of care systems in different homes.

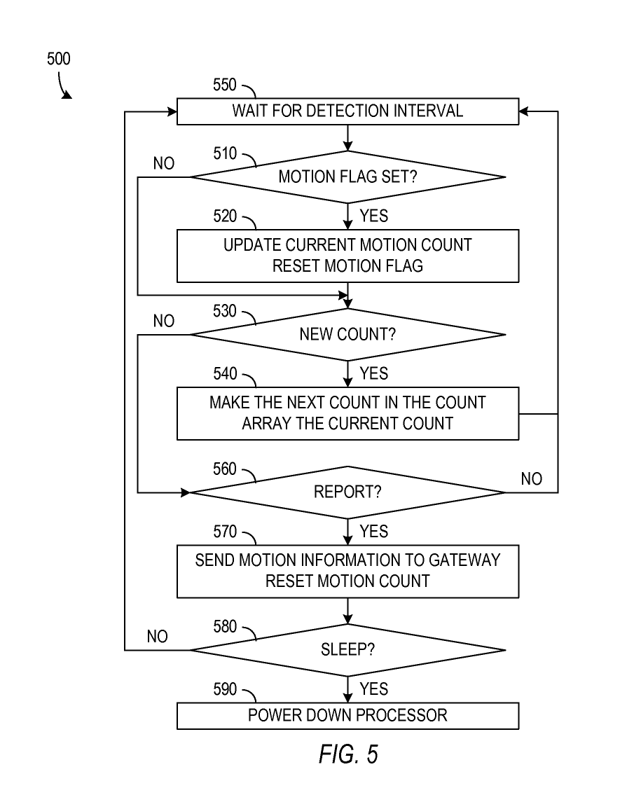

FIG. 5 is a flow diagram for one method 500 for motion monitoring in a care system. For method 500, a motion sensor has a sleep mode that reduces power consumption, for example, by powering down a processor or controller in the motion sensor. The sensing system (e.g., sensing systems 210 in FIG. 2) is active in sleep mode and can set a flag or generate an interrupt to the processor when motion is detected. When in sleep mode, the processor wakes up in response to motion being detected. The processor in the motion sensor can then execute process 500 for reporting motion. In particular, the processor in step 510 of process 500 checks to see whether the sensing system has detected motion and set a motion flag during the detection interval just ending. If so, the processor updates a motion count for the current count interval and clears the motion flag. If the motion flag is not set, the current motion count is left unchanged. As a result, the processor in step 520 can increment a motion count for the current count interval once for each detection interval during which motion was detected. After checking the motion flag and updating the current count, a step 530 determines whether to begin a new count. A new count may be begun if the motion sensor reports an array including multiple count values and if the last count value in the array has not been determined. When a count interval is complete, the motion count for that count interval indicates the number of detection intervals during which motion was detected. The detection interval is generally shorter than the count interval. For example, the detection interval may be a minute or less while the count interval is a minute or more. The motion count when the count interval is complete can have any value up to the ratio of the count interval to the detection interval and that count may be saved in a count array. If a new count is to be begun, a step 540 initializes and makes the next count value in a count array the current count. For example, the motion count can be set to zero to start counting the motion activity in the next count interval by returning to step 550 and waiting through a detection interval, during which the motion sensor may (or may not) detect motion. Repeating steps 510 to 550 can thus generate an array containing one or more count values respectively for one or more count intervals.

The processor in step 560 can determine whether it is time to report. For example, when not in sleep mode, the sensor may report motion data after a reporting period (e.g., 10 minutes) containing one or more count intervals. Alternatively, the sensor may report if one or more of the preceding count indicates no activity. If it is not time to report, process 500 branches from step 560 to a step 550 of waiting for the end of the next detection interval, and the current motion count can be incremented or not depending on whether any motion detected between clearing the motion flag in step 520 and the end of the detection interval. During a reporting period, a motion count array will be generated that provides a measure of detected activity during count intervals that make up the reporting period with higher motion counts indicating more detected movement during the corresponding count interval. In step 570, the motion sensor reports motion data (e.g., a motion count or a motion count array) to the local gateway and resets the motion data for accumulation of new motion data during the next reporting period.

Step 580, which follows the reporting of motion data to the local gateway, determines whether the motion sensor should enter sleep mode. For example, if the motion count is zero or remains zero for a specific number of count intervals or report periods, the processor can enter sleep mode in step 590 to save power and reduce the amount of data flow to the local gateway and from the local gateway to a remote server.

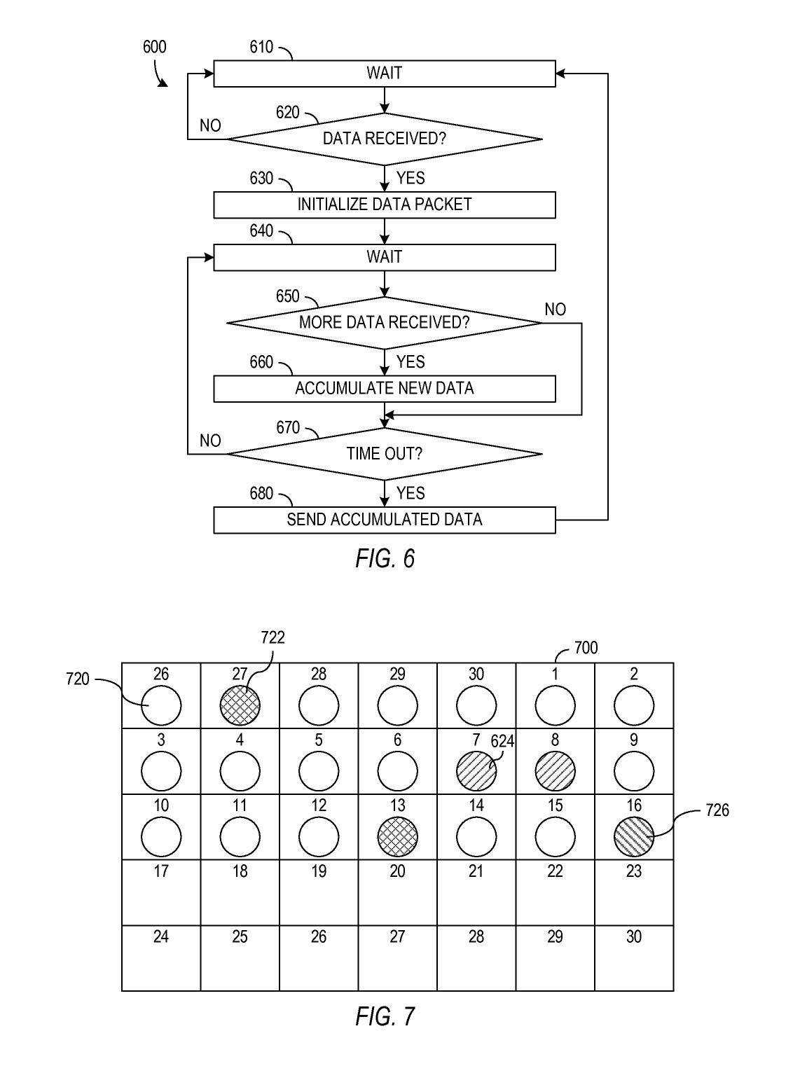

The local gateway in one embodiment of the invention may simply serve to forward sensor data (with or without a home system identifier) from local sensors to the remote service provider, and a server at the service provider can accumulate and process the data. The local gateway in an alternative implementation can compact, accumulate, or collect motion data into one or more “count tables” and send the count table arrays to the service provider. Processing or collecting of data in the local gateway instead of or in addition to the sensor techniques described herein may help offload the server's traffic overhead. FIG. 6 is a flow diagram of a process 600 in which a smart local gateway accumulates activity data before transmitting data to a remote service provider. In process 600, the gateway in step 610 waits for a transmission from a sensor in the home environment the gateway serves. Once the gateway in step 620 identifies received sensor data, the local gateway in step 630 may initialize a data block. For example, the data block may include a header identifying the home environment and data packet including the received sensor data. The local gateway then waits in step 640 for more data to be received from the same sensor or a different sensor in the home environment. If a decision step 650 determines that more data has been received, step 660 accumulates the new data into the data packet already containing prior sensor data. Step 670 determines if a time out has occurred since the gateway received either the first or the most recent sensor data. If a time out has not occurred, the gateway waits again in step 640 for more data that can be accumulated into the current data packet. If a time out has occurred, the gateway transmits the accumulated data to the remote service provider. With this technique, a server at the service provider can receive the same amount of data in few transmissions, e.g., with less Internet traffic.

The service provider can process data from a home environment to make the data more useful to a home or remote users. For example, FIG. 7 illustrates a graphical presentation of collected activity or health data on a calendar 700. For example, in the case of motion data, each block of calendar 700 representing a day for which there is data can contain a symbol or color code indicating the level of activity detected on that day. In particular, for each day, calendar 700 can contain a color code (e.g., green, yellow, or red) or symbol 720 indicating whether the home user had the activity level for the day that was good, fair, or low or whether activity occurred at expected times. Similarly, for medication that should be taken daily, each block of calendar 700 representing a day for which there is data can contain a symbol or color code indicating an automated evaluation of the data from a pillbox sensor on the designated day. In particular, for each day on which the data from the pillbox sensor indicates that a medication was taken, calendar 700 can contain a color code (e.g., green) or symbol 720 indicating that everything appears fine. On days when no pillbox activity was sensed, the calendar could contain a color code (e.g., red) or symbol 722 indicating an alarm condition. Indefinite or incomplete data can be indicated by other color codes or symbols 722 or 726. A remote user viewing the graph of FIG. 7 or an automated system using raw data from a pillbox sensor could contact or otherwise send a reminder to a home user if medication from the pillbox is not being taken as prescribed. A similar calendar can be used for any one or any combination of activity or health measurements. In a web site displaying calendar 700, each daily block can provide a link to raw data or more detailed processing information regarding that day's monitoring.

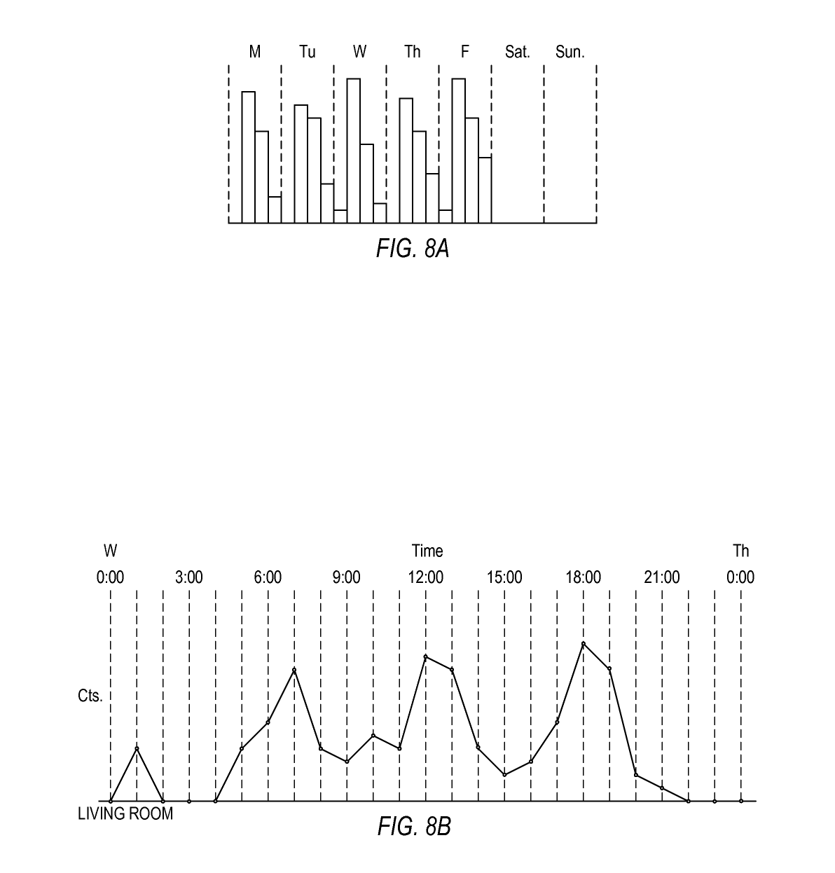

FIGS. 8A and 8B illustrate other examples of graphical representations that can be used to show an authorized user the level of activity of a home user. FIG. 8A in particular employs a bar graph containing bars representing accumulations of the motion counts for specific periods of time. A user may select the time granularity for the bar graph as fine as individual motion counts provided by a motion sensor, but FIG. 8A shows a bar graph in which each bar represents levels of activity during six hour periods that collectively span a week. FIG. 8B shows a plotted graph indicating hourly activity plotted over a twenty-four hour period and may be useful for tracking sleep patterns. FIGS. 8A and 8B further illustrate that an authorized user may be able to zoom in or out to different time scales to detect patterns of activity.

Yes-no motion detection may be employed in burglar alarms and intrusion detection systems, but the motion sensors and motion sensing techniques described herein can provide advantages in particular applications by quantify the motion detected. In particular, a motion intensity monitoring system can be advantageous for senior care uses because a measurement of motion intensity may indicate a level of the activity or health of a senior living alone. Motion detection may also be much less intrusive than are systems such as webcams because motion detection allows a home user to keep higher level of privacy. Seniors and others that may resist being “watched” by a camera may be more accepting of a care system that detects motion.

Some embodiments of the above invention may be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. A care system comprising:
a sensor configured to detect activity in a home environment within a plurality of detection periods, count the detection periods during which activity was sensed, and report one or more counts of activity; and
a gateway configured to receive reports from the sensor and to send information based on the counts and indicating the activity sensed in the home environment.

2. The system of claim 1, wherein the sensor comprises a motion sensor.

3. The system of claim 1, wherein the sensor comprises a wireless interface through which the sensor reports to the gateway.

4. The system of claim 1, wherein the sensor is battery powered.

5. The system of claim 1, further comprising a plurality of sensors configured to communicate with the gateway.

6. The system of claim 1, wherein in the gateway controls a local network of sensors and communicates with the service provider through a wide area network.

7. The system of claim 1, wherein the sensor is deployed in the home environment.

8. The system of claim 1, wherein the information quantifies levels of activity of a home user at different times.

9. The system of claim 1, further comprising a plurality of sensors configured to detect activity in a home environment and transmit data to the gateway.

10. The system of claim 1, wherein the gateway is configured to combined data from multiple reports into a data packet sent to a service provider.

11. A monitoring process comprising:
operating a sensor during a series of count intervals, wherein each count interval includes a plurality of detection intervals;
for each of the count intervals, determining a count of the detection intervals that are in the count interval and during which the sensor detected activity in a home environment of a first user;
reporting the counts to a local gateway; and
sending from the local gateway to a remote service provider information based on the counts and indicating the activity sensed in the home environment.

12. The process of claim 11, wherein reporting the counts comprises sending a series of discrete transmissions from the sensor to the gateway, and wherein each of the transmissions represents an array of the counts.

13. The process of claim 12, wherein the transmissions are separated in time at least by a reporting period.

14. The process of claim 11, further comprising the service provider sharing the information with a second user that the first user authorized to receive the information.

15. The process of claim 14, wherein sharing the information comprises the service provider processing the information and generating a message to the second user when the information satisfies a predetermined condition.

16. The process of claim 15, wherein the predetermined condition is a user selected condition.

17. The process of claim 15, wherein the predetermined condition is based on a medical criterion.

18. The process of claim 11, further comprising powering down a portion of the sensor in response to the counts indicating no activity for a period of time.

19. The process of claim 18, wherein the portion of the sensor powered down comprises a control module of the sensor.

20. A dispenser comprising:
a plurality of medication compartments;
a plurality of sensors arranged to detect accesses to respective medication compartments; and
an interface coupled to the sensors and configured to report the accesses.

21. The dispenser of claim 20, wherein each of the medication compartments has a door, and each of the sensors comprises a switch that is operated by movement of an associated one of the doors.

22. The dispenser of claim 20, wherein the interface comprises a radio transmitter.

23. The dispenser of claim 22, wherein the radio transmitter is configured to communicate with a local gateway.

24. The dispenser of claim 22, wherein the radio transmitter is battery powered.

25. A process comprising:
establishing a care system in a home environment of a home user;
reporting health information from the care system to a service accessible by a remote user, wherein the care system reports the health information with a first frequency; and
in response to a purchase, reporting the health information to the service at a second frequency that is higher than the first frequency.

26. The process of claim 25, further comprising:
employing a knowledge base to analyze the health information from the care system; and
based on analysis by the knowledge base, selecting information to be provided.
